(19) United States
(12) Patent Application Publication
(10) Pub. No.: US 2015/0002549 A1
(43) Pub. Date: Jan. 1, 2015

(54) TRANSPARENT DISPLAY DEVICE AND METHOD FOR PROVIDING USER INTERFACE THEREOF

(71) Applicant: KOREA INSTITUTE OF SCIENCE AND TECHNOLOGY, Seoul (KR)

(72) Inventors: Ji Hyung PARK, Seoul (KR); Gyu Hyun KWON, Seoul (KR); Hae Youn JOUNG, Seoul (KR)

(73) Assignee: KOREA INSTITUTE OF SCIENCE AND TECHNOLOGY, Seoul (KR)

(21) Appl. No.: 14/313,317

(22) Filed: Jun. 24, 2014

(30) Foreign Application Priority Data
Jun. 27, 2013 (KR) 10-2013-0074504

(51) Int. Cl. G06T 3/60; G09G 3/32; G06F 3/0484

(52) U.S. Cl. CPC G06T 3/60; G06F 3/04845; G09G 3/3208; G09G 2320/068; G09G 2354/00
USPC 345/650

(57) ABSTRACT

A transparent display device includes a transparent display panel to display an image through opposing first and second screens, and a driving unit to provide a user interface to the transparent display panel, and to rotate, in response to a user input, an object displayed on the first screen and display the object on the second screen. Accordingly, users located at two sides of the transparent display device may be provided with an intuitive user interface.

### CROSS-REFERENCE TO RELATED APPLICATION

This application claims priority to Korean Patent Application No. 10-2013-0074504, filed on Jun. 27, 2013, and all the benefits accruing therefrom under 35 U.S.C. §119, the contents of which in its entirety are herein incorporated by reference.

### BACKGROUND

1. Field

The present disclosure relates to a transparent display device and a method for providing a user interface thereof, and more particularly, a transparent display device which provides a metaphor environment to users located at two sides of the transparent display device to allow interaction therebetween and a method for providing a user interface thereof.

2. Description of the Related Art

Recently, with the advancement of technology, information displays are being developed on a new aspect. Among them, a transparent display has gained attention due to a unique advantage of displaying information along with a background, but failed to become popular due to its technical limitation.

With the recent development of organic light emitting diodes (OLEDs), a transparent display is more likely to be popularized in a type of a transparent OLED. A transparent OLED is expected to make technical development with advances in OLEDs. As a transparent OLED is popularized through the technology development, there is a demand for a new interface which will be provided to a user as combined with content of augmented reality and the like.

### SUMMARY

In this context, the present disclosure is directed to providing a transparent display device which provides users located at two sides with a metaphor environment to allow the users to share an object.

Also, the present disclosure is directed to providing a method for providing a user interface which provides users located at two sides with a metaphor environment using properties of the transparent display device to allow the users to share an object.

To address these issues, a transparent display device according to an exemplary embodiment includes: a transparent display panel to display an image through opposing first and second screens; and a driving unit to provide a user interface to the transparent display panel, and to rotate, in response to a user input, an object displayed on the first screen and display the object on the second screen.

In an exemplary embodiment of the present disclosure, the user input may be a hand gesture of a user.

In an exemplary embodiment of the present disclosure, the driving unit may include: an input sensing unit to sense a user input; a rotating unit to rotate the object in response to a first user input; and a control unit to generate a control signal corresponding to the user input and provide the control signal to the rotating unit.

In an exemplary embodiment of the present disclosure, the rotating unit may rotate the object 180 degrees using a line passing through a center or a side of the object as a reference line.

In an exemplary embodiment of the present disclosure, the object may include a plurality of sub-objects, and the driving unit may further include an arranging unit to arrange the sub-objects in response to a second user input.

In an exemplary embodiment of the present disclosure, the driving unit may further include a moving unit to move the object in response to a third user input.

In an exemplary embodiment of the present disclosure, the object may include a plurality of sub-objects, and the driving unit may further include an emphasizing unit to emphasize a selected sub-object visually or emphasize the selected sub-object using a vibration in response to a fourth user input.

In an exemplary embodiment of the present disclosure, the object may include a plurality of sub-objects, and the driving unit may further include an overlapping unit to overlap the sub-objects in response to a fifth user input.

In an exemplary embodiment of the present disclosure, the driving unit may further include an open unit to display detailed information of a selected sub-object in response to a sixth user input.

In an exemplary embodiment of the present disclosure, the driving unit may further include a storage unit to store the user input and the control signal corresponding to the user input.

To address these issues, a method for providing a user interface to a transparent display device which displays an image through opposing first and second screens according to another exemplary embodiment includes: displaying an object on the first screen in response to a user input; and rotating and displaying the object on the second screen in response to a user input.

In an exemplary embodiment of the present disclosure, the rotating and displaying of the object on the second screen may include rotating the object 180 degrees using a line passing through a center or a side of the object as a reference line, in response to a first user input.

In an exemplary embodiment of the present disclosure, the first input may tap and rotate the object.

In an exemplary embodiment of the present disclosure, the object may include a plurality of sub-objects, and the method for providing the user interface may further include arranging the sub-objects in response to a second user input.

In an exemplary embodiment of the present disclosure, the second input may spread the sub-objects.

In an exemplary embodiment of the present disclosure, the method for providing the user interface may further include moving the object in response to a third user input.

In an exemplary embodiment of the present disclosure, the third input may drag the object.

In an exemplary embodiment of the present disclosure, the object may include a plurality of sub-objects, and the method for providing the user interface may further include emphasizing a selected sub-object visually or emphasizing the selected sub-object using a vibration in response to a fourth user input.

In an exemplary embodiment of the present disclosure, the fourth input may click the sub-object.

In an exemplary embodiment of the present disclosure, the object may include a plurality of sub-objects, and the method for providing the user interface may further include overlapping the sub-objects in response to a fifth user input.

In an exemplary embodiment of the present disclosure, the fifth input may press, drag, and release the sub-objects.

In an exemplary embodiment of the present disclosure, a sub-object to which the press is applied longer may be arranged at topmost or bottommost.

In an exemplary embodiment of the present disclosure, the method for providing the user interface may further include displaying detailed information of the object in response to a sixth user input.

In an exemplary embodiment of the present disclosure, the sixth input may double-tap the object

According to the transparent display device and the method for providing the user interface thereof, the present disclosure allows users located at two sides of the transparent display device to use an intuitive user interface such as a hand gesture, by providing the users with a user-centered metaphor environment using properties of a transparent display. Also, the users may share an object and make realistic communications through interaction therebetween, resulting in efficient use of the transparent display device.

### BRIEF DESCRIPTION OF THE DRAWINGS

FIG. 1 is a perspective view illustrating an appearance of a transparent display device of the present disclosure.

FIG. 2 is a block diagram illustrating a driving unit of a transparent display device of the present disclosure.

FIGS. 3A-3D, 4A-4D, 5, 6A-6E, 7A-7D, 8A-8D, 9A-9H, 10-10C, and 11A-11E are diagrams illustrating a method for providing a user interface to a transparent display device according to exemplary embodiments of the present disclosure.

### DETAILED DESCRIPTION

Hereinafter, exemplary embodiments of a transparent display device and a method for providing a user interface thereof will be described in more detail with reference to the drawings.

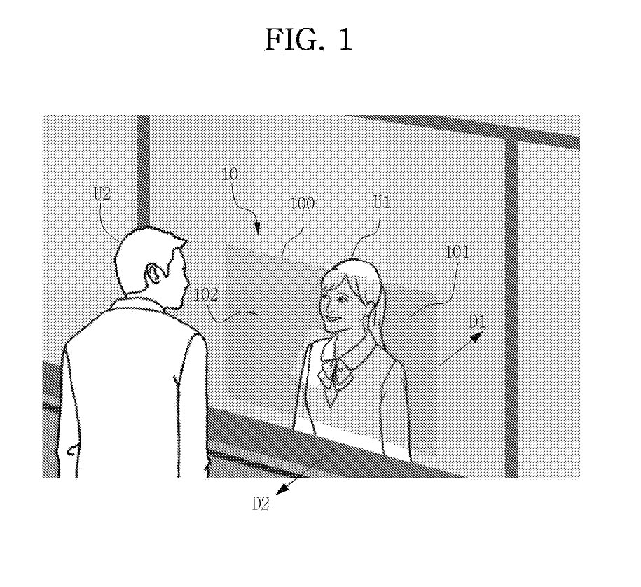

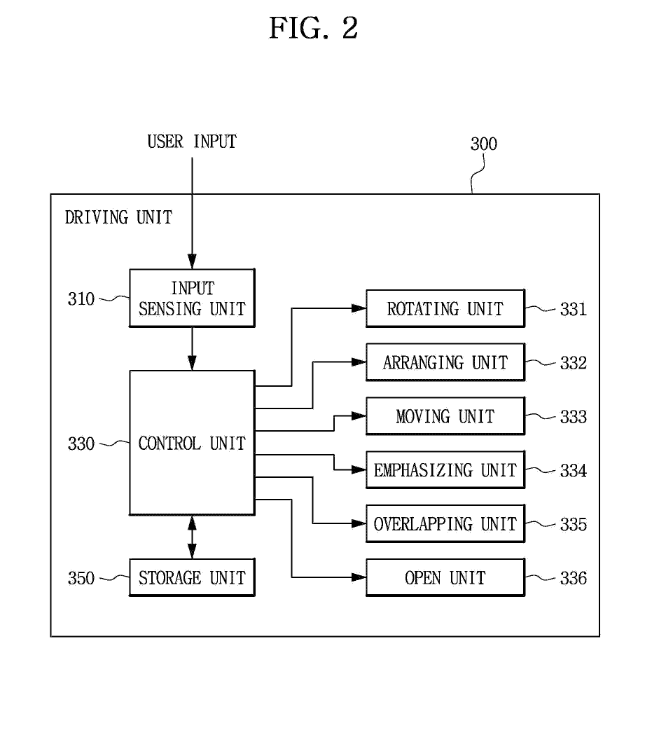

FIG. 1 is a perspective view illustrating an appearance of a transparent display device of the present disclosure. FIG. 2 is a block diagram illustrating a driving unit of the transparent display device of the present disclosure.

Referring to FIGS. 1 and 2, the transparent display device 10 according to the present disclosure includes a transparent display panel 100 to display an image, and a driving unit 300 to drive the transparent display panel 100.

The transparent display panel 100 and the driving unit 300 may be integrally formed. Alternatively, the driving unit 300 may be formed as a separate module from the transparent display panel 100, and may communicate with the transparent display panel 100 wiredly or wirelessly.

The transparent display panel 100 has a property of transmitting light while displaying an image on opposing two-sided screens 101 and 102. Accordingly, a user may visually perceive a thing or a person located at the opposite side of the transparent display panel 100.

Hereinafter, a screen which displays an image in a first direction D1 of the transparent display panel 100 is referred to as a first screen 101, and a screen which displays an image in a second direction D2 opposite to the first direction D1 is referred to as a second screen 102.

For example, a first user U1 located in the first direction D1 may view an image displayed on the first screen 101, and may observe a second user U2 located in the second direction D2. Likewise, the second user U2 located in the second direction D2 may view an image displayed on the second screen 102, and may observe the first user U1 located in the first direction D1.

The transparent display panel 100 may be of a touch screen type capable of receiving a user input, and may have a flexible property. As the transparent display panel 100, an organic light emitting diode (OLED) and a thin film electroluminescent display may be used.

The transparent display panel 100 may be driven by a passive matrix technology, and because a thin-film transistor (TFT) is not needed, light transmission may be enough high. Alternatively, even in case in which a TFT is used like an active matrix OLED, if a TFT is manufactured using a transparent material such as a multiple composition-based oxide semiconductor, sufficiently high light transmission may be ensured.

The transparent display panel 100 may be, for example, an intelligent image display with a broadcast receiving function and a computer support function in addition, and by the addition of an Internet function and the like, the transparent display panel 100 may be equipped with a more convenient interface, for example, a handwriting-type input device, a touch screen, or a space remote controller, while faithfully performing a broadcast receiving function.

Also, with the support of a wired or wireless Internet function, the transparent display panel 100 may be connected to an Internet and a computer and may perform an e-mail, web browsing, banking, or game function. For these various functions, a standard general-purpose operating system (OS) may be used.

Accordingly, the transparent display panel 100 described in the present disclosure may allow free addition or deletion of various applications, for example, on a general-purpose OS kernel, so a variety of user-friendly functions may be performed. For example, the transparent display panel 100 may be applied to a network TV, a hybrid broadcast broadband TV (HBBTV), a smart TV, a tablet computer, a laptop computer, a palmtop computer, a desktop computer, a smart phone, and the like.

Referring to FIG. 2, the driving unit 300 includes an input sensing unit 310, a control unit 330, and a rotating unit 331. The driving unit 300 may further include at least one of a storage unit 350, an arranging unit 332, a moving unit 333, an emphasizing unit 334, an overlapping unit 335, and an open unit 336.

For convenience, although FIG. 2 shows the rotating unit 331, the arranging unit 332, the moving unit 333, the emphasizing unit 334, the overlapping unit 335, and the open unit 336 as separate modules, these may be integratedly formed into one module or multiple modules. Also, the rotating unit 331 and the others are under the control of the control unit 330, and may be incorporated into the control unit 330.

The driving unit 300 provides a user interface to the transparent display panel 100, and in response to a user input, rotates an object displayed on the first screen 101 and displays the object on the second screen 102.

Also, the driving unit 300 may make a wired/wireless connection to an external device such as digital versatile disk (DVD), Blu-ray, a game console, a camcorder, a computer (a laptop computer), and the like. The driving unit 300 may provide the transparent display panel 100 with an image, a voice, or a data signal inputted from outside through the external device. Also, the driving unit 300 may provide an interface for connection to a wired/wireless network including an Internet network, and may transmit or receive data to/from another user or another electronic device via the connected network or another network linked to the connected network.

The driving unit 300 may be connected to a predetermined web page via the connected network or another network linked to the connected network. That is, the driving unit 300 may be connected to a predetermined web page via a network, and may transmit or receive data to/from a corresponding server. Besides, the driving unit 300 may receive content or data provided from a content provider or a network operator. That is, the driving unit 300 may receive, via a network, contents such as films, advertisements, games, video-on-demand (VOD), broadcast signals, and their associated information, provided from a content provider or a network provider. Also, the driving unit 300 may receive update information and an update file of firmware provided from a network operator. Also, the driving unit 300 may transmit data to an Internet or a content provider or a network operator.

The input sensing unit 310 senses a user input and transmits it to the control unit 330. The user input may be a hand gesture, a touch, a motion, a location, a voice, and a face of a user, and may use various input devices, for example, a touch screen, an input key, a camera, a keyboard, a wired or wireless input unit, and the like. Using this input device, the user may input various commands, for example, power ON/OFF, channel selection, display setting, volume control, a movement of a cursor on a screen, menu selection, function selection, and the like.

The control unit 330 controls a general operation of the transparent display device 10. To do so, the control unit 330 provides a user interface to the transparent display panel 100 and generates a control signal based on a user input.

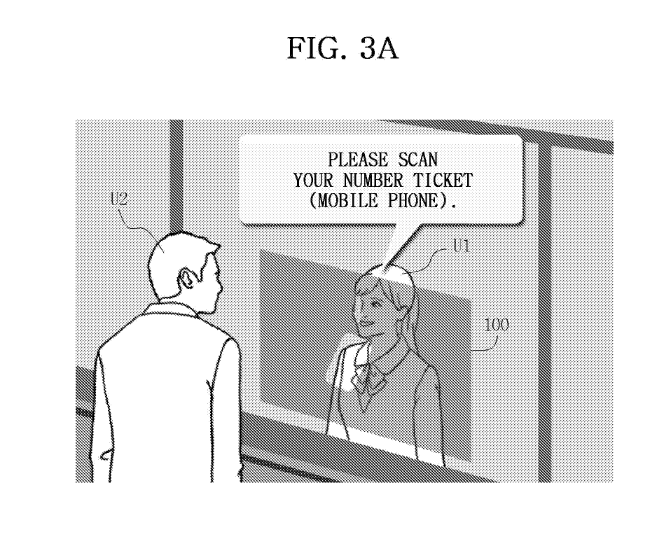

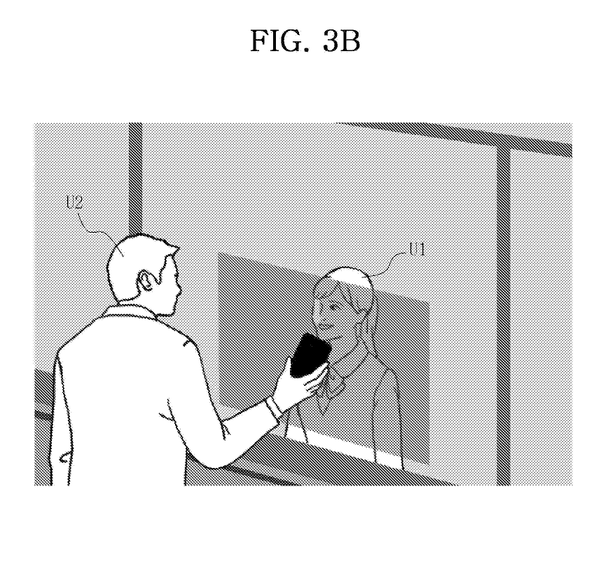

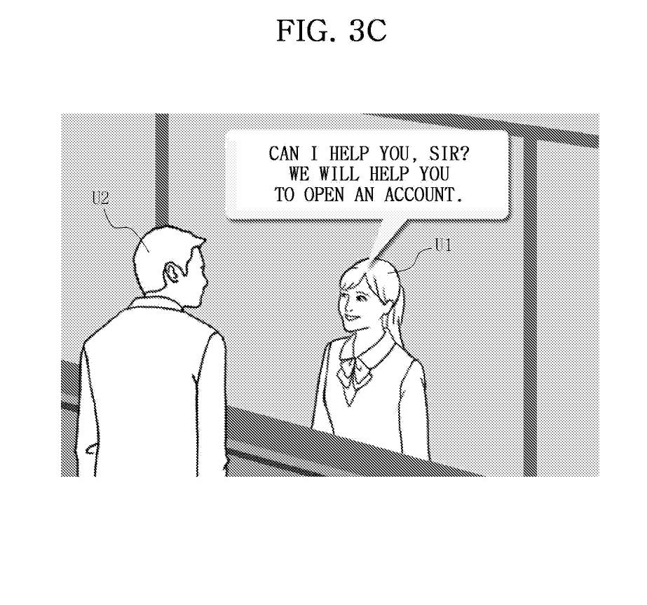

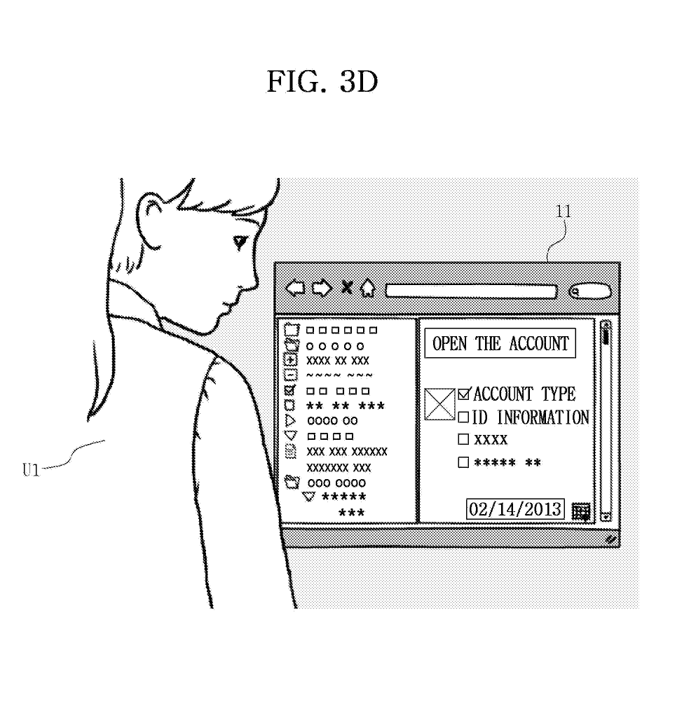

For the control unit 330 to control the rotating unit 331, the arranging unit 332, the moving unit 333, the emphasizing unit 334, the overlapping unit 335, and the open unit 336, the control unit 330 generates a control signal and provides the control signal to the rotating unit 331, etc. A detailed description of the control signal provided from the control unit 330 will be provided below with reference to FIGS. 3A through 11E.

The storage unit 350 may store each program for signal processing and control, and may store a signal-processed image, voice, or data signal. Also, the storage unit 350 may store the user input and the control signal corresponding to the user input, and in this case, the control unit 330 may output the control signal using information stored in the storage unit 350.

The storage unit 350 may include, for example, at least one type of storage medium among a flash memory type, a hard disk type, a multimedia card micro type, a card type memory (for example, a secure digital (SD) or extreme digital (XD) memory), read only memory (RAM), and electrically erasable programmable read only memory (EEPROM).

The transparent display device 10 may play a content file (a video file, a still image file, an audio file, a text file, an application file, and the like) stored in the storage unit 350, to provide it to a user.

The rotating unit 331 rotates an object displayed on the first screen 101 in response to a control signal provided from the control unit 330, and displays the object on the second screen 102. The object may include various all contents, for example, a text, a video, an image, a picture, an audio, an application, a game, and the like, and the object may include a plurality of sub-objects.

Hereinafter, a method of providing a user interface to the transparent display device 10 and controlling the transparent display device 10 based on a user input is described in detail with reference to FIGS. 3A through 11E.

A method for providing a user interface to a transparent display device according to this embodiment may be performed in the substantially same construction as the transparent display device 10 of FIG. 1. Thus, the same element as the transparent display device 10 of FIG. 1 is assigned the same reference numeral, and a repeated description is omitted.

The transparent display device 10 of the present disclosure allows sharing of an object and communications between users at the opposing sides. Accordingly, the transparent display device 10 of the present disclosure may be used in various places, for example, banks, government offices, tourist attractions, insurance companies, airports, theaters, and the like.

The following description is provided, taking an example with a situation in which a customer or a second user U2 visits a bank where a bank clerk or a first user U1 works, and they make communications across the transparent display device 10.

FIGS. 3A through 3D illustrate a process of initiating interaction between users.

Referring to FIGS. 3A through 3C, the first user U1 requests user authorization to the second user U2 who visits the bank, and once the request is responded to, the two users start interaction. The user authorization may be performed by scanning a number ticket, a mobile phone, an identification (ID) card, and the like, as put on the transparent display device 10.

Referring to FIG. 3D, the first user U1 selects a menu displayed on the first screen 101 located in the first direction D1 of the transparent display panel 100, so that an object 11 may be displayed. The first user U1 can view the object 11 and the second user U2 located at the opposite side at the same time.

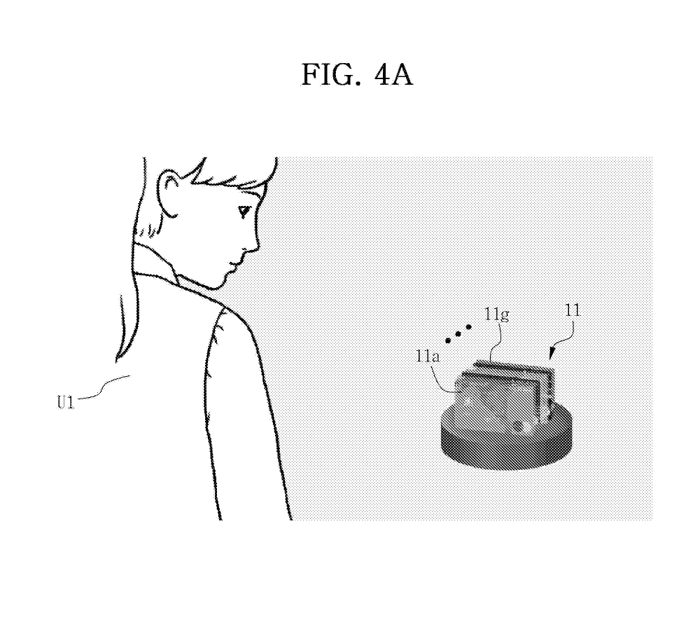

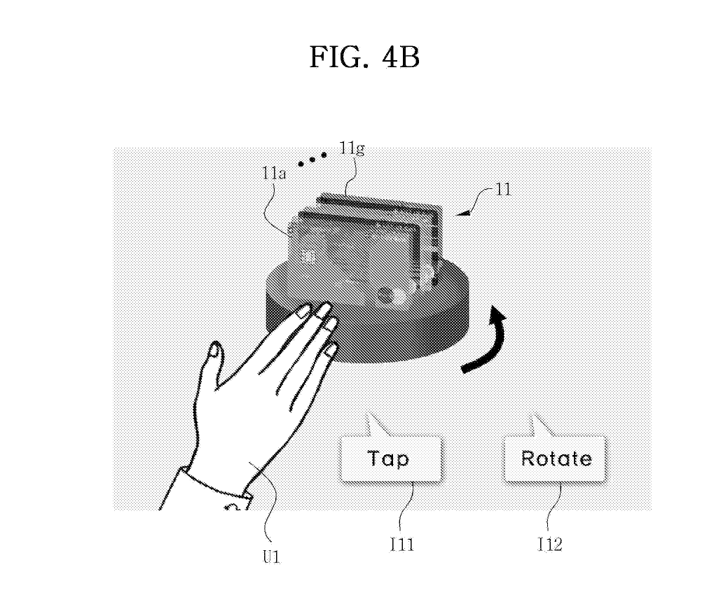

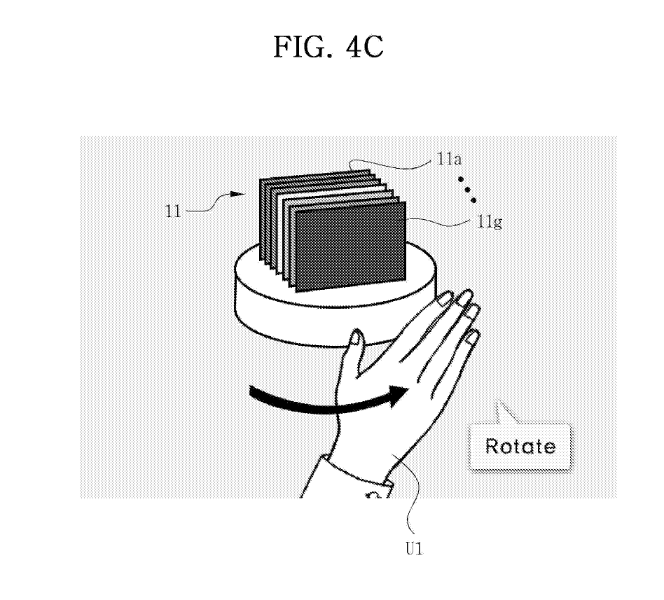

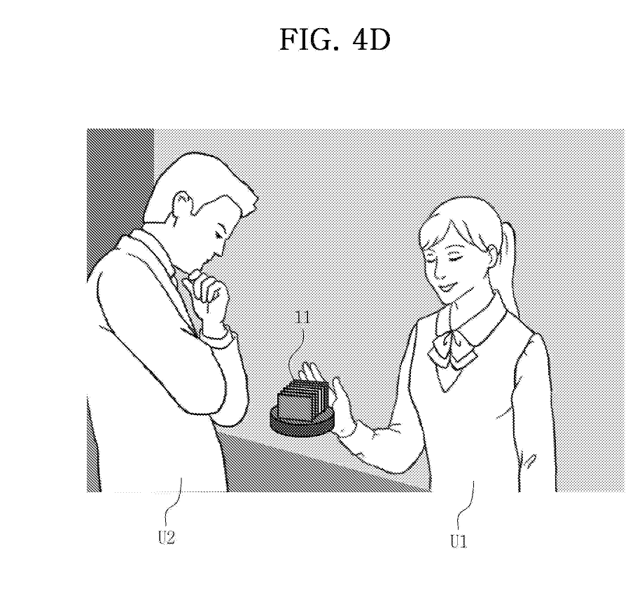

FIGS. 4A through 4D illustrate a process of rotating, in in response to a user input, an object displayed on a first screen and displaying on a second display.

The first user U1 or the second user U2 rotates the object 11 to share the object 11 with the user located at the opposite side. The object 11 may include various all contents, for example, a text, a video, an image, a picture, an audio, an application, a game, and the like, and may be displayed as a two-dimensional (2D) or three-dimensional (3D) image.

Referring to FIG. 4A, the object 11 may include a plurality of sub-objects. In this embodiment, the object 11 includes first to seventh sub-objects 11a through 11g, and each sub-object may be a card or a bankbook. The plurality of sub-objects 11a through 11g may be rotated or moved separately or as a whole.

Referring to FIGS. 4B and 4C, when the first user U1 inputs a first input I11 and I12, the control unit 330 generates a control signal for rotating the object 11 and provides the control signal to the rotating unit 331.

For example, the first input I11 and I12 may be a series of gestures for tapping I11 and subsequently rotating I12 the object 11 with a plurality of fingers. The object 11 may be rotated 180 degrees using a line passing through a center or a side of the object 11 as a reference line.

Before the object 11 is rotated, the first user U1 could view a front side of the object 11, for example, a front side of the first sub-object 11a. However, after the object 11 is rotated, the first user U1 can view a rear side of the object 11, for example, a rear side of the seventh sub-object 11g.

Referring to FIG. 4D, the object 11 is rotated 180 degrees in a rotation direction of a hand gesture of the first user U1, and is displayed on the second screen 102 at the opposite side. Thus, the second user U2 can view the front side of the object 11.

Although this embodiment describes that the first user U1 rotates the object 11, it is obvious that the second user U2 may rotate the object 11.

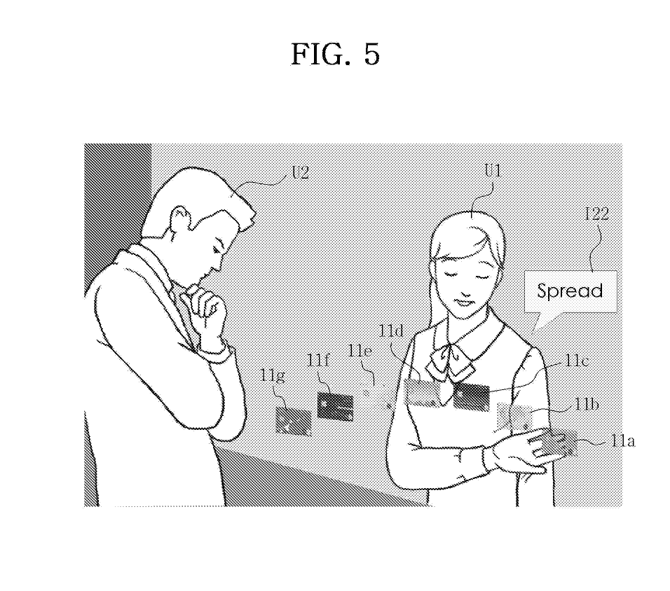

FIG. 5 illustrates a process of arranging sub-objects in response to a user input.

Referring to FIG. 5, when the first user U1 inputs a second input I22, the control unit 220 provides the arranging unit 332 with a control signal for spreading and arranging the first through seventh sub-objects 11a through 11g.

For example, the second input I22 may be a gesture for spreading the first through seventh sub-objects 11a through 11g. When the second input I22 is inputted, an arrangement order may be set to arrange the first through seventh sub-objects 11a through 11g in a sequential order or according to a necessity.

Although this embodiment describes that the first user U1 arranges the first through seventh sub-objects 11a through 11g, it is obvious that the second user U2 may arrange the first through seventh sub-objects 11a through 11g.

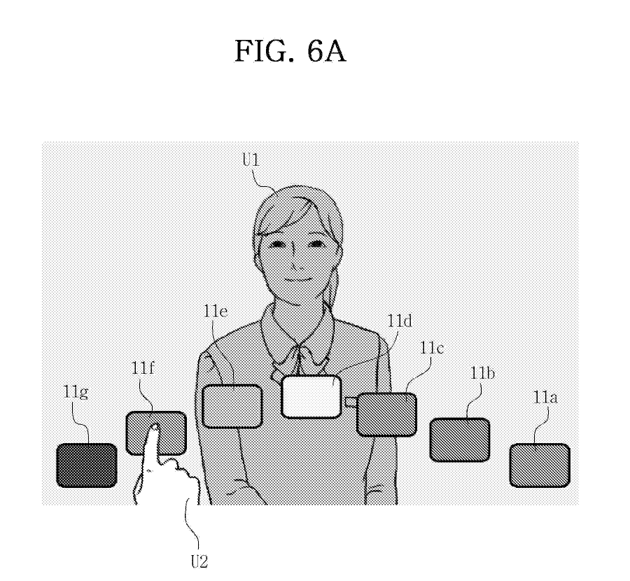

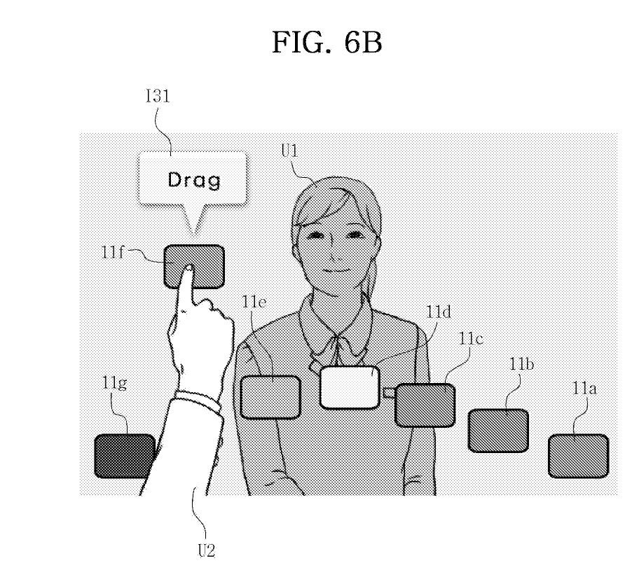

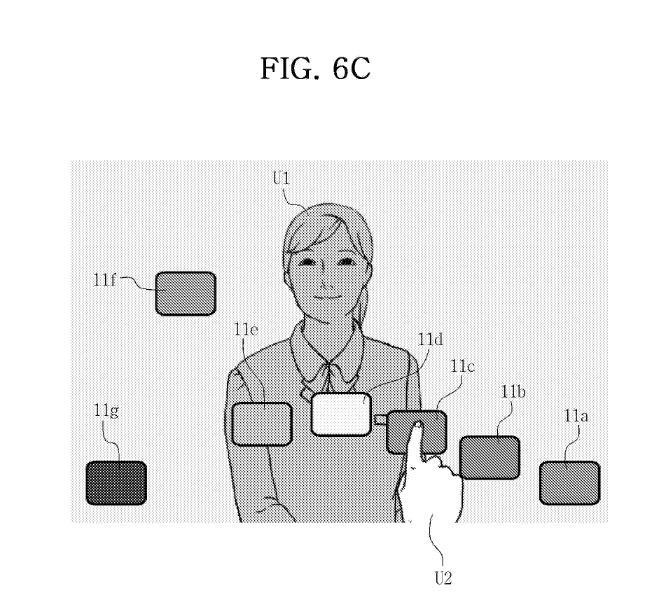

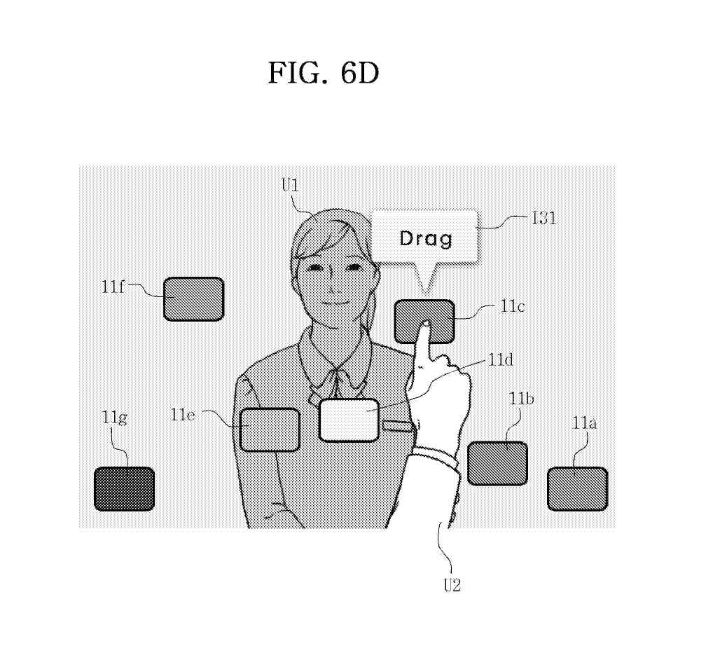

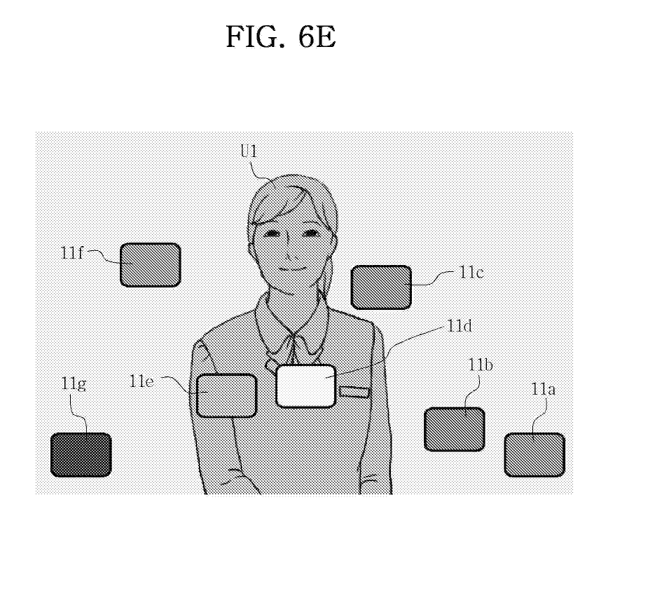

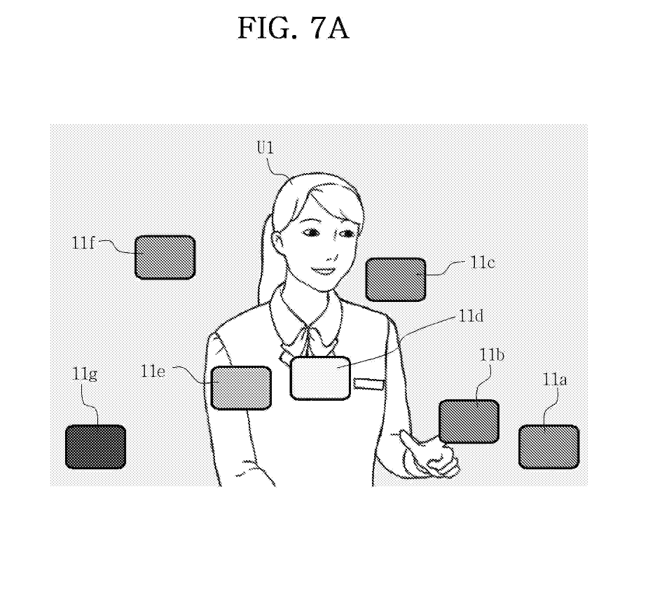

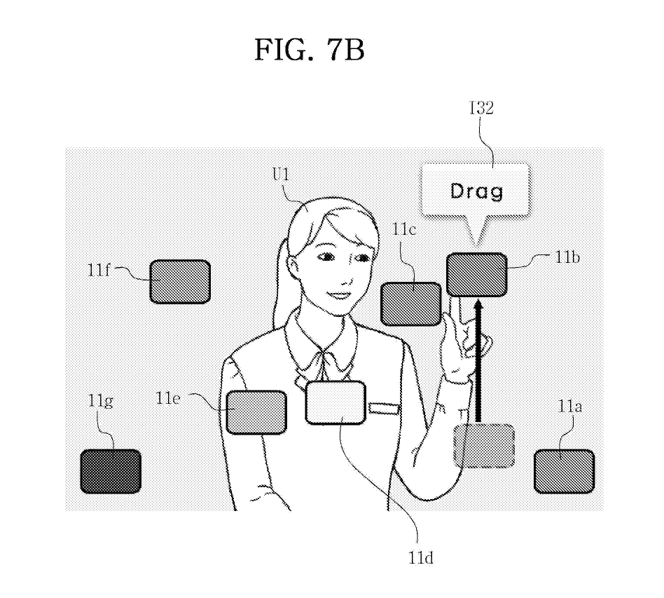

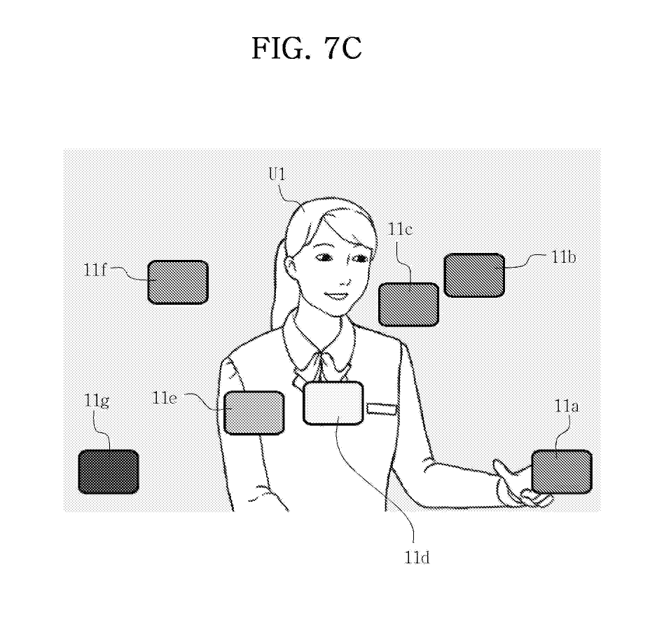

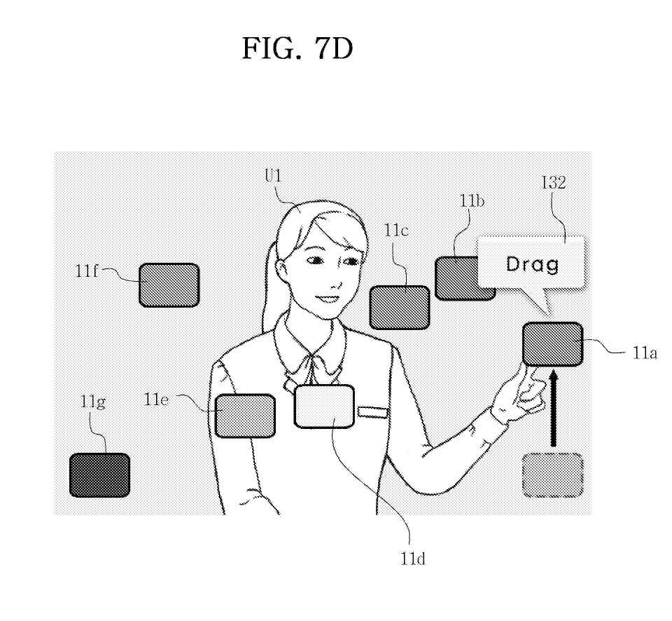

FIGS. 6A through 6E and 7A through 7D illustrate a process of moving an object in response to a user input.

Referring to FIGS. 6A and 6B, when the second user U2 inputs a third input I31, the control unit 330 provides the moving unit 333 with a control signal for moving the object 11 or a selected sub-object among the first through seventh sub-objects 11a through 11g.

For example, the third input I31 may be a gesture for selecting and dragging the object 11 or the first through seventh sub-objects 11a through 11g to be moved. The object 11 or the first through seventh sub-objects 11a through 11g selected to move may be at least two. In this embodiment, the second user U2 selects and moves the sixth sub-object 11f.

Referring to FIGS. 6C and 6D, the second user U2 selects and moves the third sub-object 11c by the same method. In this case, referring to FIG. 6E, because the front sides of the first through seventh sub-objects 11a through 11g face the second user U2, the first user U1 can view the moved rear sides of the first through seventh sub-objects 11a through 11g. However, according to necessity, the front sides and the head sides of the first through seventh sub-objects 11a through 11g may be set to be identically displayed.

Also, referring to FIGS. 7A and 7B, this time, the first user U1 selects and moves the second sub-object 11b, and referring to FIGS. 7C and 7D, selects and moves the first sub-object 11a, by the third input I32.

As described in the foregoing, each of the first user U1 and the second user U2 may select and move the object 11 or at least one of the first through seventh sub-objects 11a through 11g.

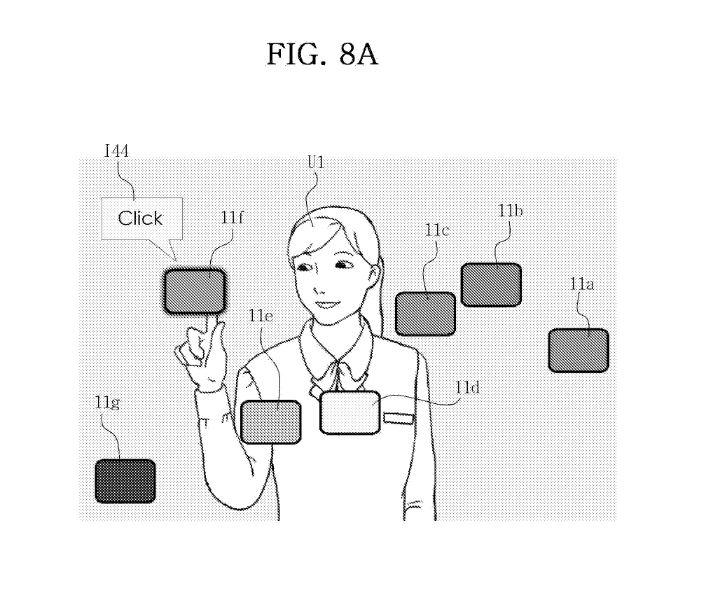

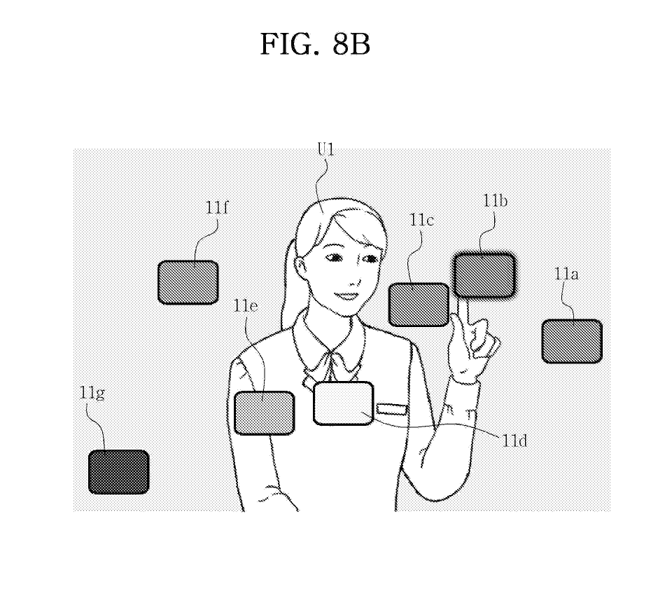

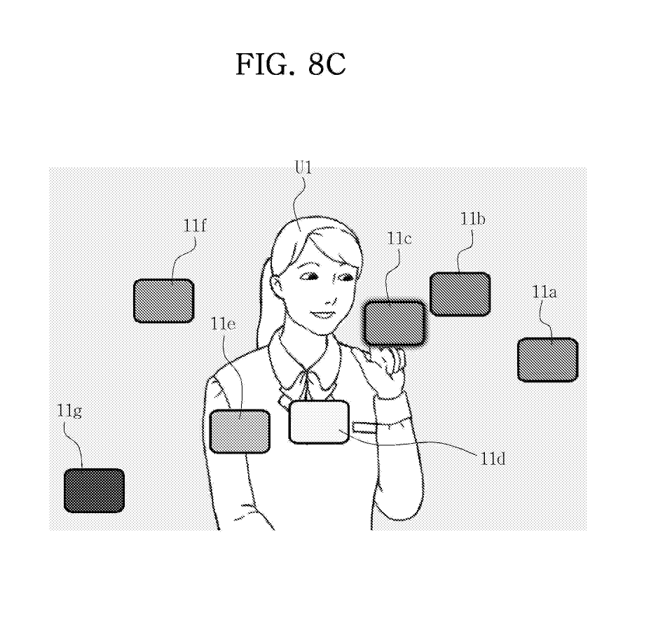

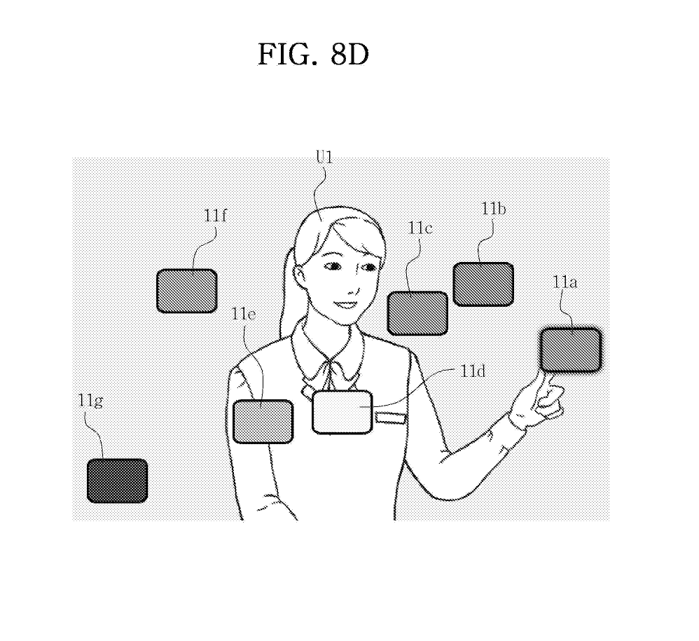

FIGS. 8A through 8D illustrate a process of emphasizing a sub-object in response to a user input.

Referring to FIGS. 8A through 8D, when the first user U1 inputs a fourth input I44, the control unit 330 provides the emphasizing unit 334 with a control signal for emphasizing the object 11 or a selected sub-object among the first through seventh sub-objects 11a through 11g.

For example, the forth input I44 may be a gesture for clicking the object 11 or the first through seventh sub-objects 11a through 11g. The object 11 or the first through seventh sub-objects 11a through 11g may be emphasized to allow a corresponding object to be perceived only while being clicked, or may be emphasized for a predetermined period of time thereafter.

For example, the clicked object may be visually emphasized by displaying a peripheral area 31 of the object using a red shadow to allow the user to easily perceive that the corresponding object was selected. Also, notification may be provided to the user by a method of providing a vibration to the selected sub-object.

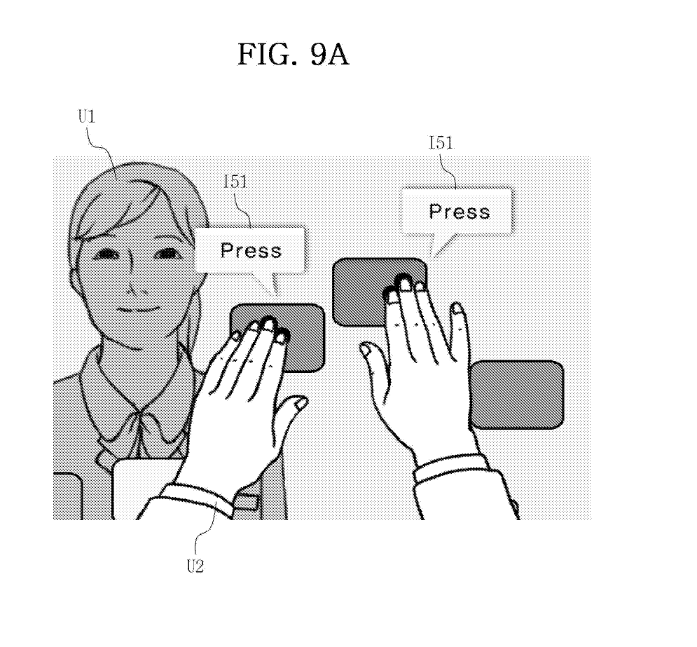

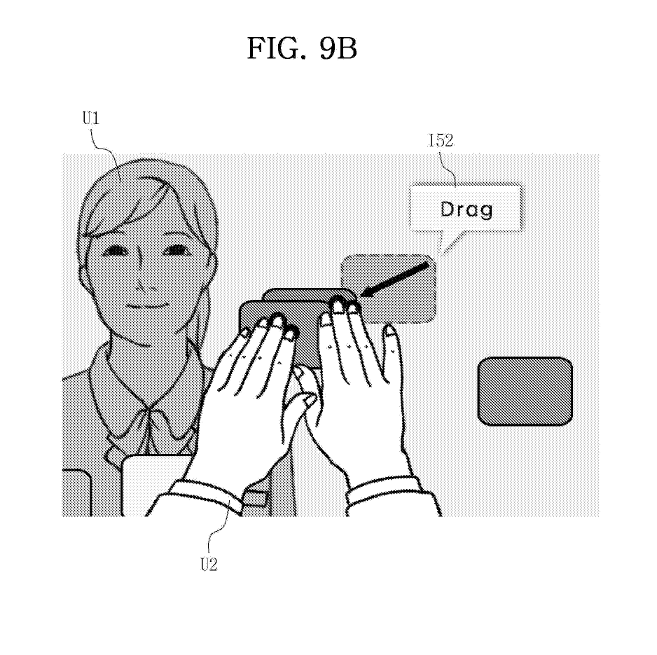

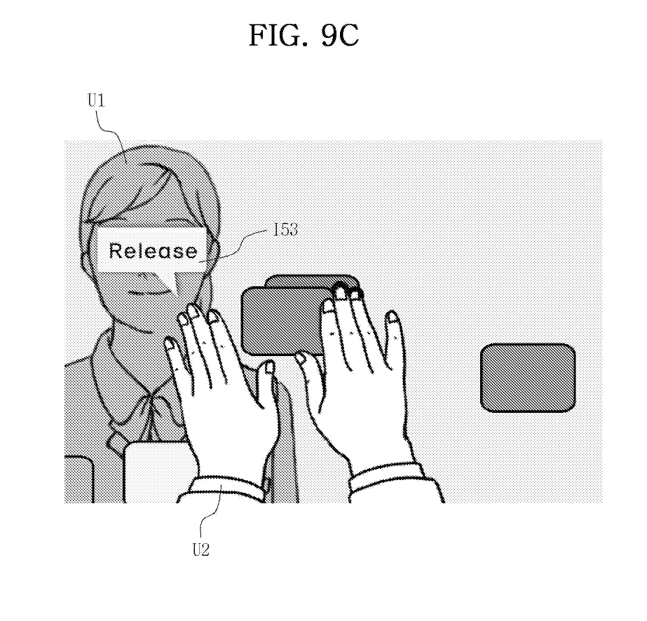

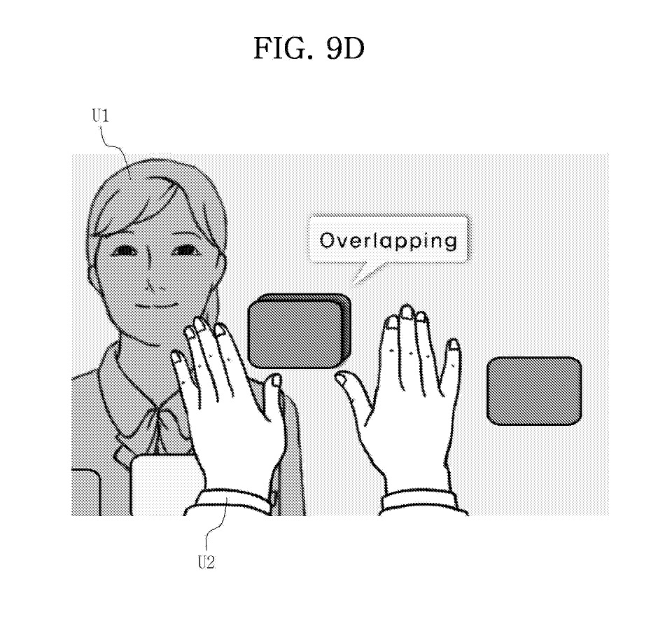

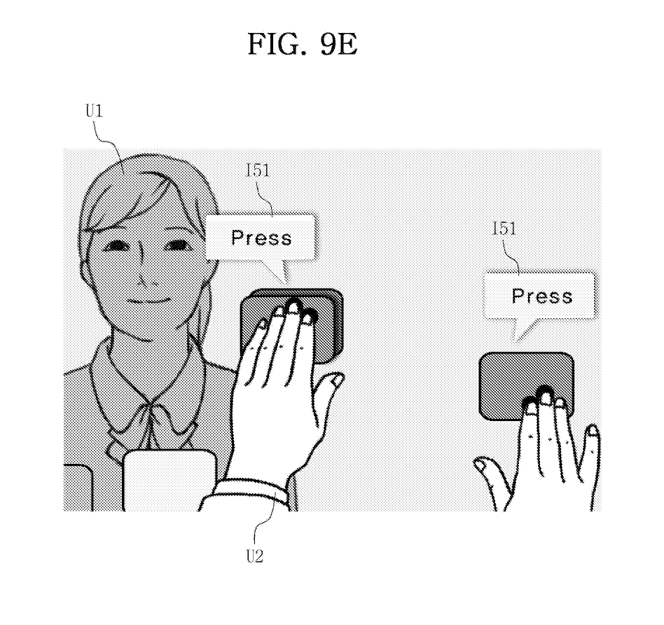

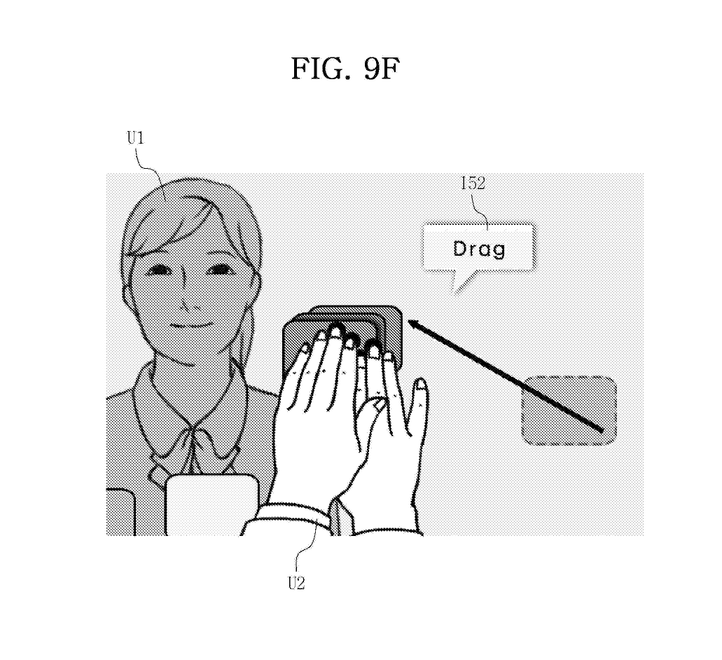

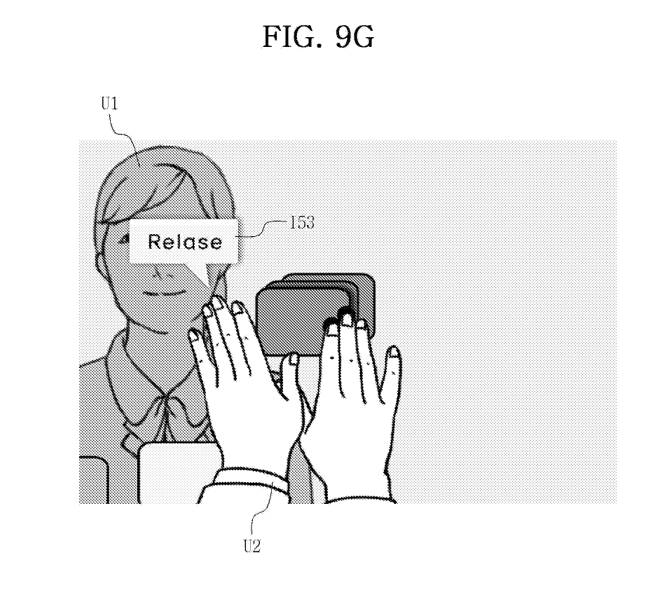

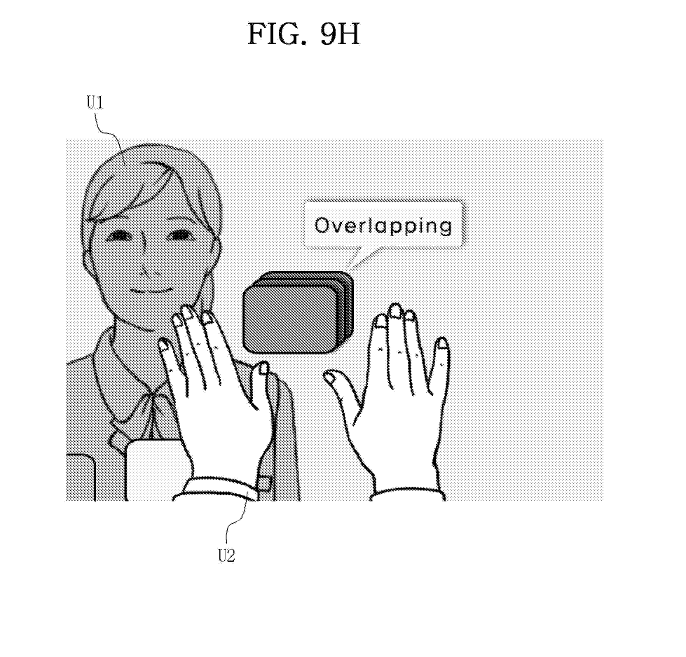

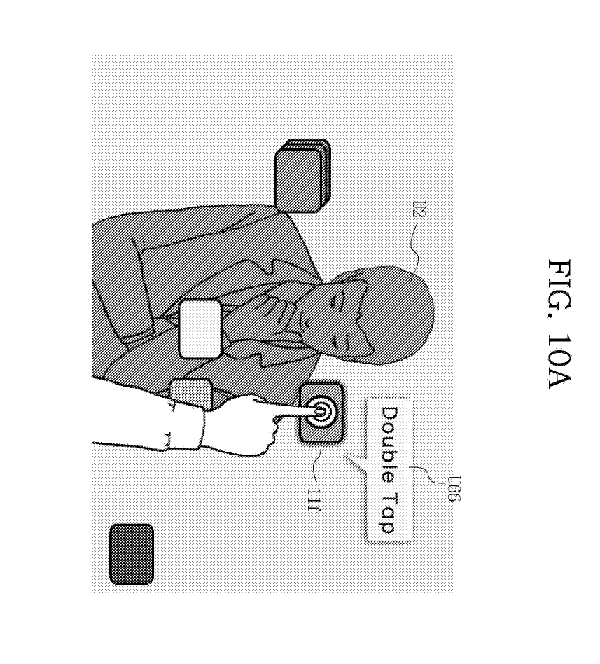

The emphasis of the object or sub-object according to this embodiment may be applied to processes to be described below in FIGS. 9A through 11E as well as the processes described in FIGS. 4A through 7D.

FIGS. 9A through 9H illustrate a process of overlapping sub-objects in response to a user input.

Referring to FIGS. 9A through 9D, when the first user U1 inputs a fifth input I51, I52, and I53, the control unit 330 provides the overlapping unit 335 with a control signal for overlapping the object 11 or the first through seventh sub-objects 11a through 11g.

For example, the fifth input I51, I52, and I53 may be a series of gestures for pressing I51 and dragging I52 two sub-objects to be overlapped, and after the sub-objects are overlapped, and releasing I53 the sub-objects.

When the sub-objects are overlapped, a sub-object to which the press I51 is applied longer, that is, a sub-object to which the release I53 is applied the latest may be set to be arranged at topmost or bottommost. In this case, the sub-object arranged at topmost may be set to be visually emphasized or to be provided with a vibration, to allow perception of the user.

Referring to FIGS. 9E through 9H, when the first user U1 selects the fifth input I51, I52, and I53 again, the sub-objects may be re-overlapped on the previously overlapped sub-objects.

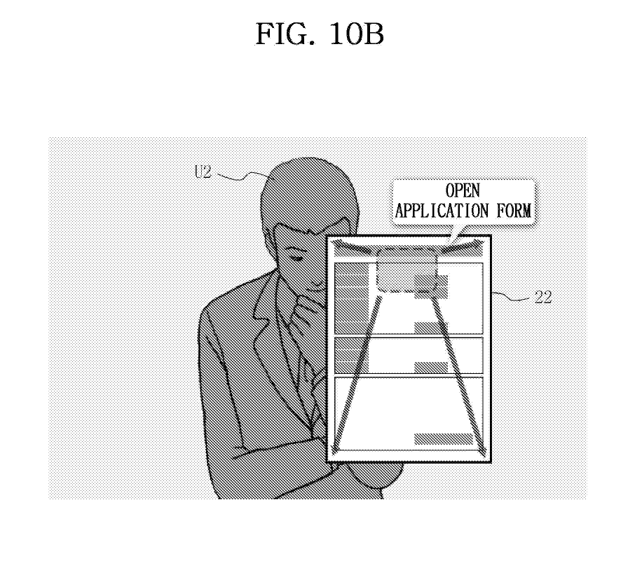

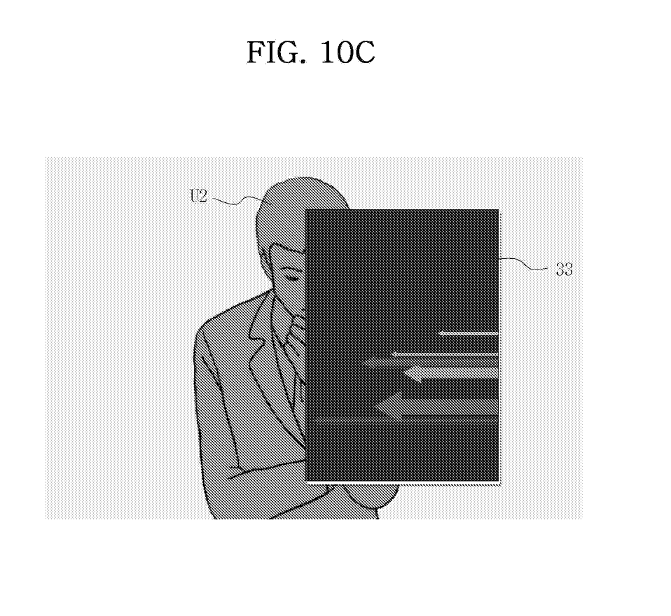

FIGS. 10A through 10C illustrate a process of displaying detailed information of an object or a sub-object in response to a user input.

Referring to FIG. 10A, when the first user U1 inputs a sixth input I66, the control unit 330 provides the open unit 336 with a control signal for opening detailed information of the object 11 or a selected object among the first through seventh sub-objects 11a through 11g.

For example, the sixth input I66 may be a gesture for double-tapping the object 11 or the first through seventh sub-objects 11a through 11g. The detailed information may be stored in the open unit 336, or may be retrieved from the storage unit 350.

Referring to FIG. 10B, an example is presented in which an application form 22 is opened as detailed information of the sixth sub-object 11f selected by the first user U1, and referring to FIG. 100, an example is presented in which a guidebook 33 including a plurality of pages is opened.

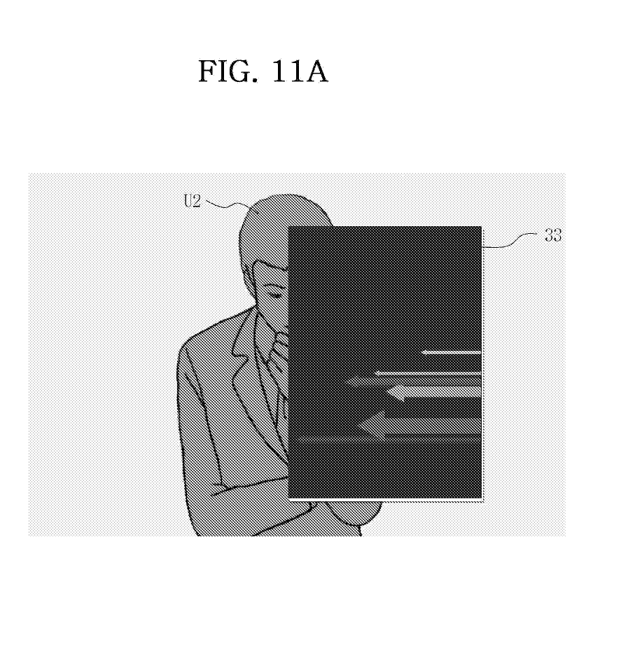

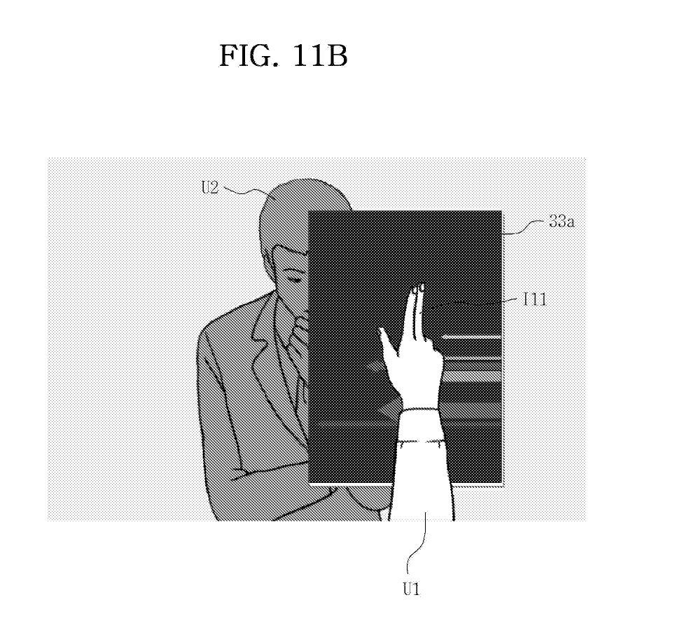

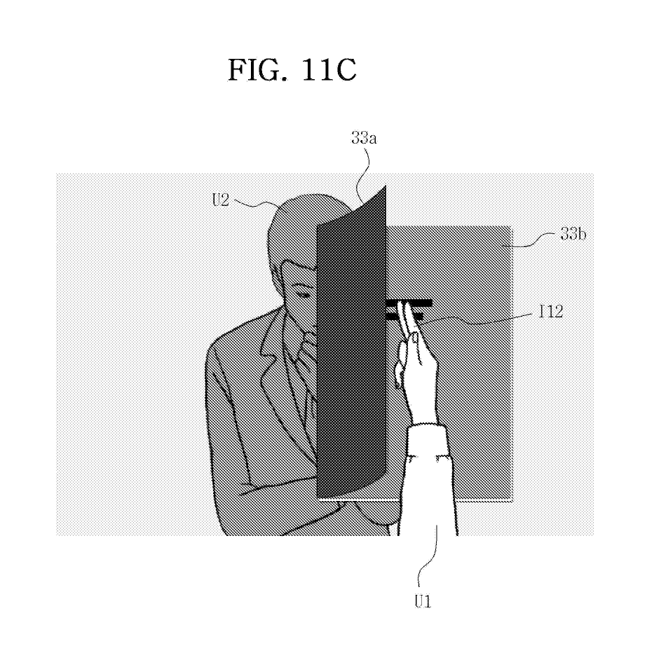

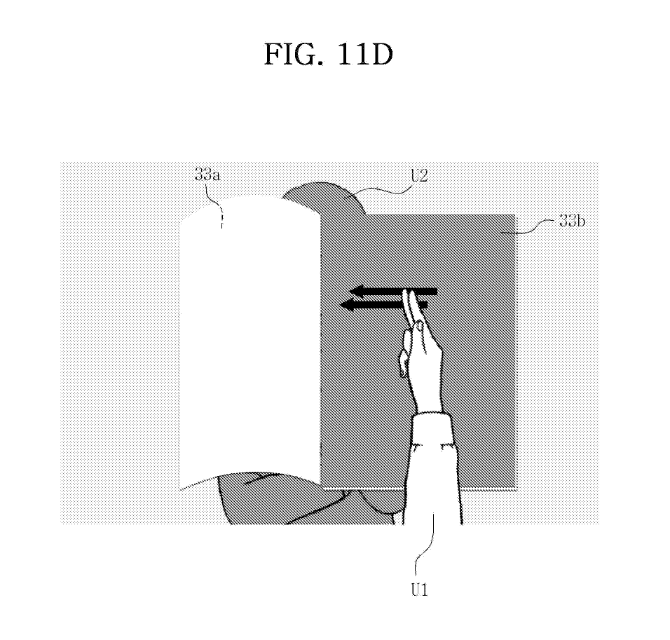

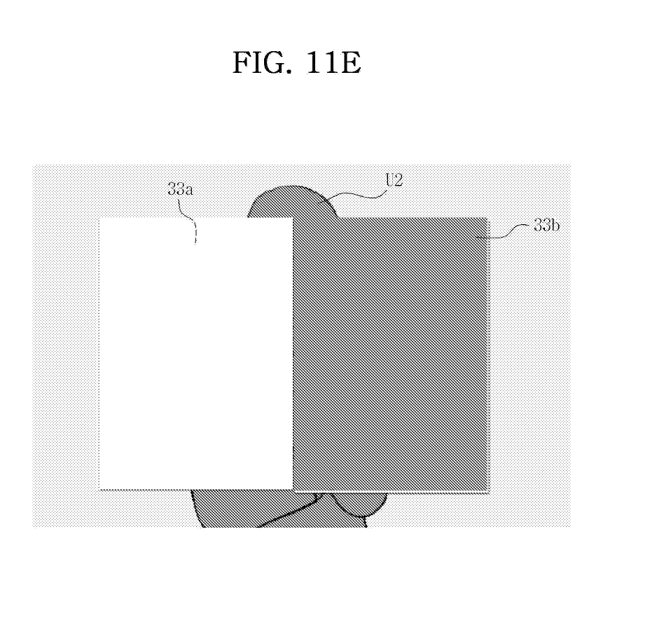

FIGS. 11A through 11E illustrates a process of sharing the guidebook opened in FIGS. 10A through 100 with a user located at the opposite side while turning a page.

Referring to FIG. 11A, the first user U1 can view a front side of the guidebook 33, and at the same time, can view the second user U2 at the opposite side. The first user U1 turns a page of the guidebook 33 to share the guidebook 33 with the user at the opposite side. This is similar to a method of turning a page of a book and thus allows the user to use an intuitive hand gesture.

Referring to FIGS. 11B through 11D, when the first user U1 inputs a first input I11 and I12, the control unit 330 generates a control signal for rotating a first page 33a of the guidebook 33, and provides the control signal to the rotating unit 331.

For example, the first input I11 and I12 may be a series of gestures for tapping I11 and subsequently rotating I12 the first page 33a with a plurality of fingers. The first page 33a may be rotated 180 degrees using a line passing through a left side surface of the guidebook 33 as a reference line.

Referring to FIG. 11E, the first page 33a is rotated 180 degrees in a direction facing the second user U2 and displayed on the second screen 102 at the opposite side. Accordingly, the second user U2 can view the first page 33a. Also, the first user U1 views a second page 33b of the guidebook 33. In this way, the first user U1 can turn the page of the guidebook 33, and it is obvious that the second user U2 may turn the page of the guidebook 33.

In FIGS. 11A through 11E, each page 33a and 33b of the guidebook 33 corresponds to a sub-object of FIGS. 4A through 4D. That is to say, an entire object may be rotated and displayed on the screen at the opposite side as in the embodiment of FIGS. 4A through 4D, and only a part of an object, that is, a sub-object or a page may be rotated and displayed on the screen at the opposite side as in the embodiment of FIGS. 11A through 11E.

According to the transparent display device and the method for providing the user interface thereof according to this embodiment, a user-centered metaphor environment may be provided to users located at two sides of the transparent display device using properties of a transparent display, thereby allowing the users to use an intuitive user interface such as a hand gesture. Accordingly, the users may make realistic communications through interaction therebetween, resulting in efficient use of the transparent display device.

While the present disclosure has been described with reference to the above embodiments, it is obvious to those skilled in the art that various modifications and changes may be made to the present disclosure without departing from the spirit and scope of the present disclosure set forth in the appended claims.

What is claimed is:

1. A transparent display device, comprising:
a transparent display panel to display an image through opposing first and second screens; and
a driving unit to provide a user interface to the transparent display panel, and to rotate, in response to a user input, an object displayed on the first screen and display the object on the second screen.

2. The transparent display device according to claim 1, wherein the user input is a hand gesture of a user.

3. The transparent display device according to claim 1, wherein the driving unit comprises:
an input sensing unit to sense a user input;
a rotating unit to rotate the object in response to a first user input; and
a control unit to generate a control signal corresponding to the user input and provide the control signal to the rotating unit.

4. The transparent display device according to claim 3, wherein the rotating unit rotates the object 180 degrees using a line passing through a center or a side of the object as a reference line.

5. The transparent display device according to claim 3, wherein the object includes a plurality of sub-objects, and the driving unit further comprises an arranging unit to arrange the sub-objects in response to a second user input.

6. The transparent display device according to claim 3, wherein the driving unit further comprises a moving unit to move the object in response to a third user input.

7. The transparent display device according to claim 3, wherein the object includes a plurality of sub-objects, and the driving unit further comprises an emphasizing unit to emphasize a selected sub-object visually or emphasize the selected sub-object using a vibration in response to a fourth user input.

8. The transparent display device according to claim 3, wherein the object includes a plurality of sub-objects, and the driving unit further comprises an overlapping unit to overlap the sub-objects in response to a fifth user input.

9. The transparent display device according to claim 3, wherein the driving unit further comprises an open unit to display detailed information of a selected sub-object in response to a sixth user input.

10. The transparent display device according to claim 3, wherein the driving unit further comprises a storage unit to store the user input and the control signal corresponding to the user input.

11. A method for providing a user interface to a transparent display device which displays an image through opposing first and second screens, the method comprising:
displaying an object on the first screen in response to a user input; and
rotating and displaying the object on the second screen in response to a user input.

12. The method for providing the user interface according to claim 11, wherein the rotating and displaying of the object on the second screen comprises rotating the object 180 degrees using a line passing through a center or a side of the object as a reference line, in response to a first user input.

13. The method for providing the user interface according to claim 12, wherein the first input taps and rotates the object.

14. The method for providing the user interface according to claim 11, wherein the object includes a plurality of sub-objects, and the method further comprises arranging the sub-objects in response to a second user input.

15. The method for providing the user interface according to claim 14, wherein the second input spreads the sub-objects.

16. The method for providing the user interface according to claim 11, further comprising moving the object in response to a third user input.

17. The method for providing the user interface according to claim 16, wherein the third input drags the object.

18. The method for providing the user interface according to claim 11, wherein the object includes a plurality of sub-objects, and the method further comprises emphasizing a selected sub-object visually or emphasizing the selected sub-object using a vibration in response to a fourth user input.

19. The method for providing the user interface according to claim 18, wherein the fourth input clicks the sub-object.

20. The method for providing the user interface according to claim 11, wherein the object includes a plurality of sub-objects, and the method further comprises overlapping the sub-objects in response to a fifth user input.

21. The method for providing the user interface according to claim 20, wherein the fifth input presses, drags, and releases the sub-objects.

22. The method for providing the user interface according to claim 21, wherein a sub-object to which the press is applied longer is arranged at topmost or bottommost.

23. The method for providing the user interface according to claim 11, further comprising displaying detailed information of the object in response to a sixth user input.

24. The method for providing the user interface according to claim 23, wherein the sixth input double-taps the object.
